(19) United States
(12) Patent Application Publication
(10) Pub. No.: US 2026/0064891 A1
(43) Pub. Date: Mar. 5, 2026

(54) SYSTEM FOR SECURE REMOTE MANAGEMENT OF CRYPTOGRAPHIC DEVICES

(71) Applicant: Lee W. Smith, Arlington, VA (US)

(72) Inventor: Lee W. Smith, Arlington, VA (US)

(21) Appl. No.: 18/822,863

(22) Filed: Sep. 3, 2024

(51) Int. Cl. G06F 21/72; G06F 21/86

(52) U.S. Cl. CPC G06F 21/72; G06F 21/86

(57) ABSTRACT

A device for secure remote management of cryptographic devices is provided. The device includes a plurality of components disposed of within the housing of the device. The plurality of components includes a first router, a second router, a first encryption device, a second encryption device, and a next unit of computing device. Each of the first and second routers are configured to route traffic from one or more networks, including at least one public and one private network. Each of the encryption devices are configured to encrypt traffic for information security. The next unit of computing is configured to secure remote access to at least one of the encryption devices, allowing configuration, update, or other interfacing with at least one of the encryption devices.

### BACKGROUND OF THE INVENTION

### Field of Invention

The present invention relates to remote device management and, more particularly, to a system for secure remote management of cryptographic devices.

### Description of Related Art

Cryptographic products are designed to meet the rigorous security requirements of government and military organizations, ensuring the confidentiality, integrity, and authenticity of sensitive data transmitted across communication networks. They employ advanced encryption algorithms and key management techniques to safeguard information from unauthorized access or interception. However, specific details about these products may be subject to classification or proprietary information restrictions. Traditionally, these security requirements and physical key loading render remote management impossible, as remote access can compromise the security of these devices, leaving cleared, trained, and authorized in-person management the only option. Organizations have thousands of these devices stationed worldwide thereby requiring the deployment of personnel and costs associated therewith each time management of a device is needed.

One solution for remote management of cryptographic devices utilizes a second cryptographic device to create a secure tunnel, or secure authority association, with a cryptographic device, disposed between a public network and a private network, to be monitored and/or managed. The secure authority can then perform monitoring utilizing at least one device connected through this secure authority. However, upon failure of the cryptographic device to be managed, the connection drops to the secure authority and to all networks connected to the cryptographic device to be managed, which leaves all users in the dark as to the type of failure, or if the failure is even due to the cryptographic device. Furthermore, because monitoring is performed remotely no monitoring data can be transmitted and or evaluated to determine a cause of the failure.

As can be seen, there is a need for a secure system for remote management of cryptographic devices thereby eliminating the need or minimizing the requirements for in-person management.

### SUMMARY OF THE INVENTION

In one aspect of the present invention, a device for secure remote access is provided. The device includes a housing for housing a plurality of components including a first router, a second router, a first cryptographic device, a second cryptographic device, and a computing device. The first router includes a plurality of ports and is configured to access at least one first network, such as a public network. The second router includes a plurality of ports and is configured to access at least one second network, such as a private network. The first cryptographic device is communicative coupled to the first router and the second router and is configured to encrypt at least one data received from one or more devices. The second cryptographic device is communicatively coupled to the first router and the computing device and is configured to encrypt at least one data received from one or more devices, wherein the at least one data is not stored by the second cryptographic device. Then a computing device is communicatively coupled to the first cryptographic device and the second cryptographic device, wherein the computing device is configured to provide remote access to the first cryptographic device and the second cryptographic device.

In another aspect of the present invention, a method for secure management or monitoring of at least one computing device is provided. The method begins by monitoring at least one computing device. During monitoring, at least one failure of one computing device can be detected. In response to detecting at least one failure of the computing device, one secure connection to the computing device can be formed. Remote management can then be performed on the failed device utilizing at least one secure connection.

These and other features, aspects and advantages of the present invention will become better understood with reference to the following drawings, description, and claims.

### BRIEF DESCRIPTION OF THE DRAWINGS

FIG. 1 is a block diagram of an embodiment of a system for secure remote management of cryptographic devices, according to aspects of the present invention;

FIG. 2 is a block diagram of an embodiment of a device for secure remote management, according to aspects of the present invention; and

FIG. 3 is a block diagram of an embodiment of a method for secure remote management, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Traditionally, rigorous security requirements associated with cryptographic devices have rendered remote management of these devices infeasible, or impossible, leaving in-person management as the sole mechanism for management. For example, traditional networks that utilizing cryptographic devices include at least one public router configured to provide access to public/unsecure networks, such as the Internet, at least one private router configured to provide access to private/secure networks configured to provide operational security and privacy, and at least one encryptor device to encrypt traffic from the at least one private router such that it can be securely transmitted over public/unsecure networks. These networks can be monitored remotely by secure virtual private network (VPN) tunnel through an encryption device. However, a change in status of the network such as key material expiration in the encryptor, key deletion, or the circuit's bandwidth drops below a threshold, power failure, or a power fluctuation, or a network configuration change, causes the secure tunnel to drop, by design, leaving network administrators in the dark as to the cause or position of the network failure.

Numerous disadvantages are associated with in-person management of cryptographic devices including inefficiencies associated with the time and costs associated with putting “boots on the ground” to manage these devices, and lack of real-time management capabilities.

Broadly, one embodiment of the present invention is a system for secure remote management of cryptographic devices. The system includes at least one device including a plurality of components such as a plurality of edge service routers, a plurality of cryptographic devices, and a next unit of computing device all interconnected to provide secure remote access to the plurality of cryptographic devices.

In the present invention, a first edge service router specifically optimized for edge computing and routing tasks can be deployed at the edge of a network where it can interface and provide access to an external network, such as the Internet, and internal networks, such as LANs, WANs, etc. In the present invention, the plurality of cryptographic devices can be connected to the first edge service router to provide traffic through the first edge service router. A second edge service router of the plurality of router specifically optimized for edge computing and routing tasks can be deployed at the edge of at least one private network, where it can interface with the plurality of cryptographic devices, and internal private networks, such as private LANs, WANs, etc. A next unit of computing device, as a small form-factor, barebones computer, including a dual Network Interface Controller (NIC) can be connected to the plurality of cryptographic devices to provide secure access to the plurality of cryptographic devices and to provide monitoring functionality. The device includes a plurality of ports configured to transmit traffic through the plurality of components of the device.

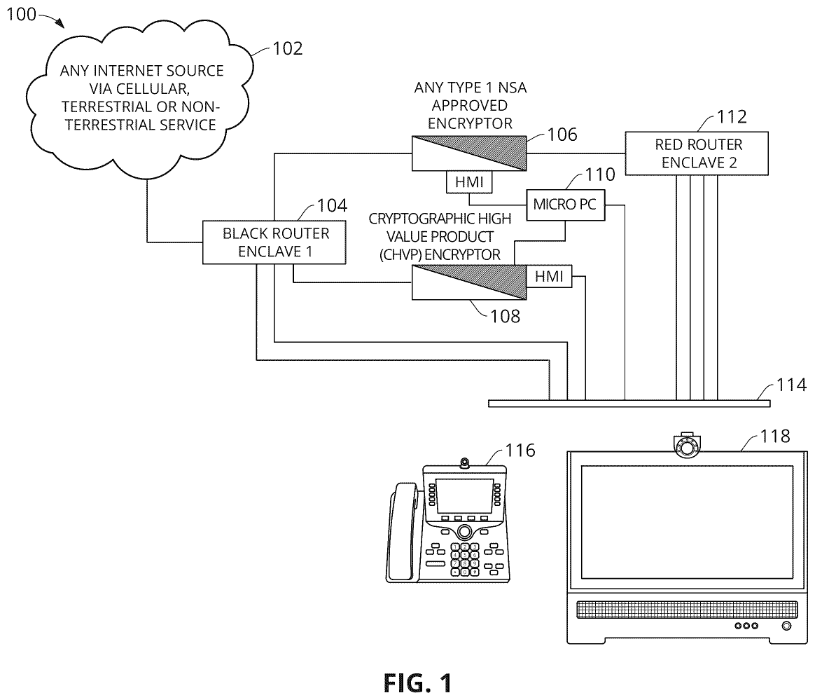

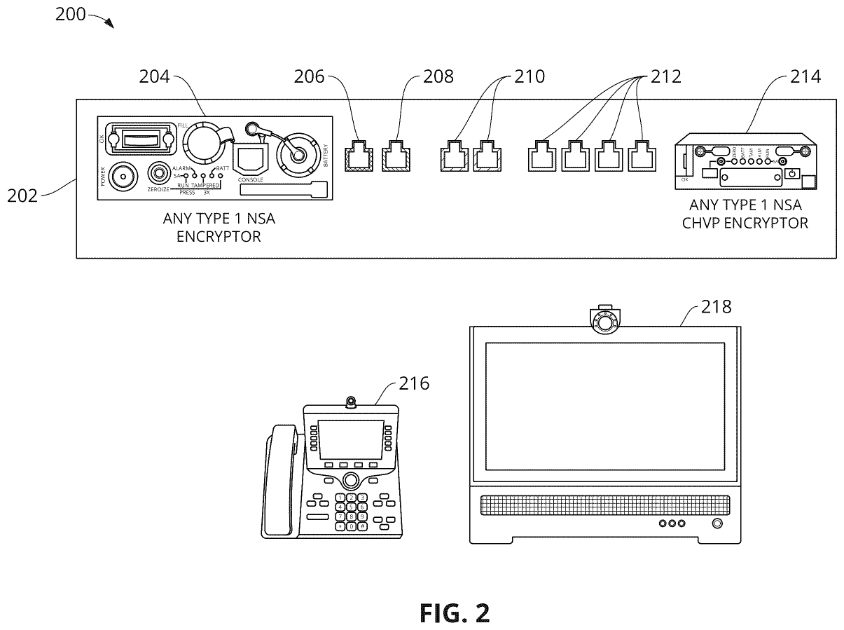

Referring to FIGS. 1-2, aspects of the system 100 for secure remote management of cryptographic devices are illustrated. System 100 can be configured to provide access to/through any network 102, which can include any available network communication protocols and/or wired or wireless communication protocols known in the art, such as cellular, wireless, terrestrial, and/or non-terrestrial protocols, through secure remote management device 114 (same as device 200).

Secure remote management device 114 includes a plurality of components disposed therein and configured to provide access to at least one public and at least one private network, through both encrypted and non-encrypted channels, and to provide access for secure remote management to a subset of the plurality of components. Secure remote management device 114 includes a plurality of ports 206-212 (described further below) configured to provide connectivity amongst the plurality of devices and the at least one public and the at least one private network. Secure remote management device 114 can house the plurality of components including: a first router 104, a first encryption device 106, a second encryption device 108, a next unit of computing 110, and a second router 112.

In embodiments, first router 104 can be a router with a plurality of ports 206-208 configured to provide a user access to at least one public network, such as the Internet. In embodiments, first router 104 can be a network device manufactured and designed by most major router and network device manufacturer that serves as a key component in enterprise networking infrastructure. Specifically, first router 104 can be an edge service router that can be specifically optimized for edge computing and routing tasks, typically deployed at the edge of a network where it interfaces with external networks, such as the internet, and internal networks, such as LANs (Local Area Networks) or WANs (Wide Area Networks).

In embodiments, first router 104 can be configured to provide a user, or computing system, a plurality of functionalities, described hereinafter. In embodiments, first router 104 can perform routing functions, directing network traffic between different networks based on IP addresses and routing protocols such as OSPF (Open Shortest Path First) or BGP (Border Gateway Protocol), or any protocol known in the art. In this manner, first router 104 can determine the most efficient paths for data packets to reach their destinations. In addition to routing, first router 104 can also support edge computing capabilities, allowing it to execute applications and services directly at the network edge. Advantageously, this enables faster processing of data and reduces the need to send all traffic to centralized data centers.

First router 104 can include robust security features to protect the network and its users from various threats, such as firewall capabilities, VPN (Virtual Private Network) support, intrusion detection and prevention systems (IDPS), and access control mechanisms. First router 104 can support Quality of Service (QoS) features to prioritize certain types of network traffic, ensuring that critical applications receive sufficient bandwidth and latency requirements are met. First Router 104 can be designed for high availability, with features such as redundant power supplies, hot-swappable components, and support for protocols like HSRP (Hot Standby Router Protocol) or VRRP (Virtual Router Redundancy Protocol) for router failover. Additionally, first router 104 can be a scalable device, capable of handling increasing network traffic and accommodating additional network devices or users as the network grows. Finally, first router 104 can include management and monitoring tools that allow network administrators to configure, monitor, and troubleshoot the router remotely, ensuring smooth operation and quick resolution of any issues.

In embodiments, second router 112 can be a router with a plurality of ports 212 configured to provide a user access to at least one private network, such as a government, military, or commercially private network, and at least one public network through at least one of encryption devices 106 and 108. In embodiments, second router 112 can be a network device manufactured and designed by most major router and network device manufacturer that serves as a key component in enterprise networking infrastructure. Specifically, second router 112 can be an edge service router that can be specifically optimized for edge computing and routing tasks, typically deployed at the edge of the at least one private network where it interfaces with the private network and other networks through one or more of the first encryption device 106 and/or the second encryption device 108.

In embodiments, second router 112 can be configured to provide a user, or computing system, a plurality of functionalities, described hereinafter. In embodiments, second router 112 can perform routing functions, directing network traffic between different networks based on IP addresses and routing protocols such as OSPF (Open Shortest Path First) or BGP (Border Gateway Protocol), or any protocol known in the art. In this manner, second router 112 can determine the most efficient paths for data packets to reach their destinations. In addition to routing, second router 112 can also support edge computing capabilities, allowing it to execute applications and services directly at the network edge. Advantageously, this enables faster processing of data and reduces the need to send all traffic to centralized data centers.

Second router 112 can include robust security features to protect the network and its users from various threats, such as firewall capabilities, VPN (Virtual Private Network) support, intrusion detection and prevention systems (IDPS), and access control mechanisms. Second router 112 can support Quality of Service (QoS) features to prioritize certain types of network traffic, ensuring that critical applications receive sufficient bandwidth and latency requirements are met. Second Router 112 can be designed for high availability, with features such as redundant power supplies, hot-swappable components, and support for protocols like HSRP (Hot Standby Router Protocol) or VRRP (Virtual Router Redundancy Protocol) for router failover. Additionally, second router 112 can be a scalable device, capable of handling increasing network traffic and accommodating additional network devices or users as the network grows. Finally, second router 112 can include management and monitoring tools that allow network administrators to configure, monitor, and troubleshoot the router remotely, ensuring smooth operation and quick resolution of any issues.

In embodiments, first encryption device 106 can be an encryption device designed to meet rigorous security requirements of government and military organizations, such as a National Security Administration Type 1 security device, operating the Suite A and/or Suite B (also known as Commercial National Security Algorithm Suite) set of algorithms. Type 1 security devices have passed a rigorous process that included testing and formal analysis of (among other things) cryptographic security, functional security, tamper resistance, emissions security (EMSEC/TEMPEST), and security of the product manufacturing and distribution process. In embodiments, first encryption device 106 can be configured to ensure the confidentiality, integrity, and authenticity of sensitive data transmitted across communication networks. First encryption device 106 employs advanced encryption algorithms and key management techniques to safeguard information from unauthorized access, or interception. In embodiments, first encryption device can be logically and/or communicatively coupled to first router 104 and second router 112 and configured to encrypt traffic, or data, from second router 112 and transmit the encrypted traffic, or data, to first router 104 for dissemination to outside networks.

In embodiments, advanced encryption algorithms can include Suite A and/or Suite B cryptography, as promulgated by the National Security Agency (NSA). For example, Suite B algorithms may include, but are not limited to, Advanced Encryption Standard (AES) with key sizes of 128 and 256 bits. For traffic flow, AES should be used with either the Counter Mode (CTR) for low bandwidth traffic or the Galois/Counter Mode (GCM) mode of operation for high bandwidth traffic, Elliptic Curve Digital Signature Algorithm (ECDSA), Elliptic Curve Diffie-Hellman (ECDH), and/or Secure Hash Algorithm 2 (SHA-256 and SHA-384).

In embodiments, first encryption device 106 can include a Human Machine Interface (HMI) configured to provide access to the device and to control, configure, modify, update, or otherwise interface with device 106.

In embodiments, second encryption device 108 can be an encryption device, the same as, or similar to first encryption device 106, with the exception that it operates Type 1, with only Suite B (also known as commercial national security algorithm suite) encryption. Additionally, second encryption device 108 can be a cryptographic high value product (CHVP) encryptor. In embodiments, second encryption device 108, as a CHVP encryptor, can be configured to encrypt information, in a manner similar to or the same as first encryption device 108, but allows for the remote creation of Device Generated Secure Key (DGSK). DGSK can be created via the HMI interface on next unit of computing 110, described further below. The use of the CHVP device allows the remote embodiment no need to store or retain any classified information. In embodiments, second encryption device 108 can include a Human Machine Interface (HMI) configured to provide access to the device and to control, create DGSK, configure, modify, update, or otherwise interface with second encryption device 108. Additionally, second encryption device 108 is configured to provide secure access to HMI of first encryption device 106 as a secure back-door in case of a failure.

In embodiments, second encryption device 108 can run advanced encryption algorithms as promulgated by the NSA, including Suite B, or Commercial National Security Algorithms Suite. In embodiments, these algorithms can include, but are not limited to, Advanced Encryption Standard with 256 bit keys, Elliptic-curve Diffie-Hellman and Elliptic Curve Digital Signature Algorithm with curve P-384, SHA-2 with 384 bits, Diffie-Hellman key exchange with a minimum 3072-bit modulus, and RSA with a minimum modulus size of 3072.

In embodiments, next unit of computing (NUC) 110 can be a computing device with a small form factor, such as Intel's® Next Unit of Computing (NUC) platform. In embodiments, NUC 110 can include various components such as at least one processor, memory, storage, and various connectivity devices. In embodiments, NUC 110 includes at least two network interface cards (NIC) configured to connect NUC 110 to one or more additional computing devices. In embodiments, the at least two NIC configurations, also referred to as “dual-NIC”, allows NUC to connect to two different networks simultaneously or providing redundancy for network connections. In embodiments, second encryption device 108 can be logically and/or communicatively coupled to first router 104 and NUC 110, and can be configured to provide commands to first encryption device 106 through NUC 110. Additionally, in embodiments second encryption device 108 is not logically/communicatively coupled to second router 112, thereby maintaining security of second router 112.

In embodiments, NUC 110, also referred to as dual NIC NUC 110, is configured to provide various functionalities. In embodiments, Dual NICs allow for the separation of traffic or implementation of network security features like firewalling and intrusion detection/prevention. In embodiments, a first NIC of NUC 110 can be configured for regular network traffic while a second NIC of NUC 110 can capture packets for analysis or monitoring purposes. Additionally, dual NICs can facilitate network connectivity for virtual machines running on the NUC, providing separate network interfaces for different virtualized environments. Additionally, NUC 110 can be logically and/or communicatively separate from networks accessible by first router 104, and/or second router 112, thereby promoting security. Finally, with two NICs NUC 110 can function as a router or gateway device, routing traffic between two separate networks or providing internet access to multiple devices. Advantageously, dual NIC NUC 110 provides flexibility in networking configurations, making it suitable for a wide range of applications that require compact yet powerful computing solutions with multiple network connectivity options.

In operation, secure remote management device 114, also labeled 200, can have a plurality of modes, including at least an operational mode, and a management mode. In embodiments, secure remote management device 114 can be deployed in a configured, or unconfigured, state and can be connected to the plurality of networks outlined above. In embodiments, secure remote management device 114 can include an interface portion 202, where a user can interact with the plurality of components such as first encryption device 204, labeled 106 above, second encryption device 214, labeled 108 above, first router 104 and second router 112. In embodiments, ports 206-212 can provide access to the plurality of components and/or access to one or more networks, described above.

In embodiments, ports 206 and 208 can provide direct access to at least one public network, such as the Internet, to a user connected to secure remote management device 114. In embodiments, a first port 210 can be configured to provide access to HMI of second encryption device 214 without the need for an encryption key. In embodiments, access through the first port 210 allows a user communication to pass through HMI of second encryption device 214 to NUC 110, where it can be utilized to configure, update, modify, or otherwise interface with first encryption device 204. In embodiments, second encryption device 214, as a CHVP, allows for communication between a user and first cryptographic device 204 without storage of classified information, thereby maintaining information security. In an exemplary embodiment, the first port 210 can be connected to a computing device, such as a computer, laptop, server, etc., for failsafe management. The computing device can be assigned a specific manual IP address which is reachable by second encryption device 214. The HMI of second encryption device 214 can be reached via a simplified web browser interface, which can be accessed by user inputting an IP address of the HMI into the simplified web browser interface of the computing device. Once accessed, the HMI of the second encryption can be utilized to configure, update, modify, or otherwise interface with first encryption device 204. In embodiments, access through the first port 210 can be always on, or actuatable through a switch controlled by a user, such as a manual switch.

A second port 210 can be configured to provide direct access to NUC 110. In embodiments, due to this direct access, the second port 210 would be able to allow an external PC or laptop to operate for maintenance on the same IP network and VLAN, LAN as the NUC. The external computing device can be utilized to manage updates or logs, and or review updates or logs locally. The second port of 210 can only provide limited functionality. For example, functionality provided through the second port 210 can download and provide information about traffic data, or other information useful in analysis for encrypted data traffic flowing to the first and second encryption devices 204 and 214.

In embodiments ports 212 are configured to provide operational access to a plurality of devices, such as computing devices, peripherals, phones, etc. In embodiments, the plurality of devices are connected to ports 212, which provides access to the functionality at least the first encryption device 204. In embodiments, the plurality of devices can operate securely within private networks, and provide encrypted traffic to a plurality of networks. Advantageously, configuration of secure remote management device 200 in this manner allows for traditional operation of encryption devices while allowing remote management.

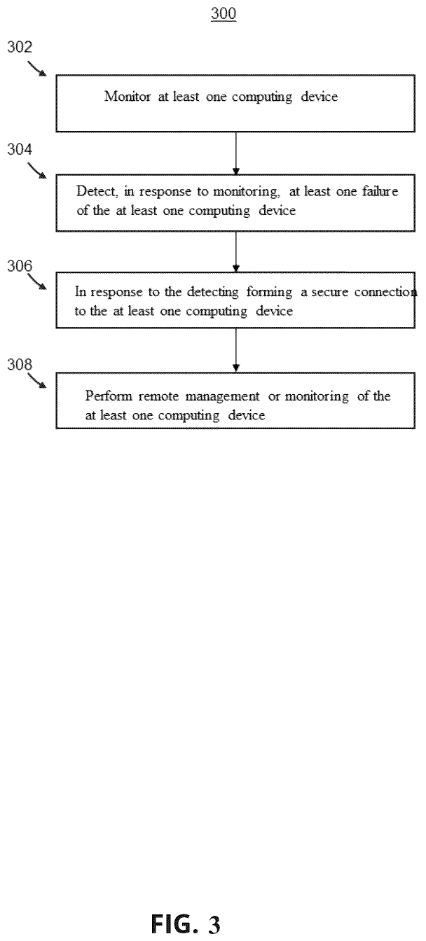

Referring now to FIG. 3, a method for secure remote management of cryptographic devices 300 is illustrated. In embodiments, secure remote management device 114 can be utilized to perform the method. In embodiments, secure remote management can be implemented as Cryptography-as-a-Service (CaS), utilizing encryption and management as implemented through cloud services, or in the alternative secure remote management can be implemented through any known paradigm.

Secure remote management method 300 begins at step 302 with monitoring of encryption devices, such as first encryption device 106. In embodiments, monitoring of encryption devices can be performed by at least one computing device within a secure, private, or encrypted network. For example, monitoring can be performed by at least one computing device communicatively coupled to at least one of ports 212 of second router 112, which is communicatively coupled to first encryption device 106. In embodiments, the at least one computing device can include one or more electronic devices such as a laptop computer, a desktop computer, a tablet computer, a smartphone, a thin client, a smart appliance, and the like. Additionally, internal monitoring of traffic and/or functionality of first encryption device 106 and/or second encryption device 108 utilizing NUC 110. In embodiments, the at least one computing device can be configured to monitor the status, and/or functionality of first encryption device, and the HMI of the second encryption device 108.

At step 304, at least one failure can be detected via monitoring of second router 112. In embodiments, failure can be detected by at least one event occurring during the monitoring of second router 112 by the at least one computing device. For example, the at least one computing device can provide at least one event indicating that peripherals 116 and/or 118 (also 216 and 218), such as computing devices, servers, telephones, or other electronic devices, connected through ports 212 have stopped producing network traffic. In embodiments, the at least one failure can be due to a failure of first encryption device 106, such as key material expiration in first encryption device 106, key deletion, or the circuit's bandwidth drops below a threshold, power failure, or a power fluctuation, or a network configuration change. In embodiments, the at least one failure can, by design, drop a secure connection of first encryption device 106.

At step 306, in response to the failure at least one computing device can access first encryption device 106 and perform remote management. In embodiments, HMI of first encryption device 106 can be accessed by the at least one computing device through access to second encryption device 108 and subsequent access to NUC 110. In embodiments, the at least one computing device can send at least one command to the HMI of second encryptor 108, which can be forwarded to HMI of first encryptor 106 through NUC 110. In embodiments, the at least one command can be a command to monitor, update, change, modify, extract, or otherwise interface with first encryptor 106. In embodiments, the at least one command can be at least one of: Net Time Protocol, making device IP configuration changes, adding dynamic route configurations, adding new net managers, and periodic firmware upgrades. In embodiments, once HMI of first encryption device 106 is accessed through the computing device, via second encryptor 108, a user can perform remote management such as diagnostics, and/or repair. In embodiments, the user can utilize the HMI of first encryption device 106, though HMI of second encryptor device, to perform re-keying, reconfiguration, and/or log checking of first encryption device 106.

In embodiments, NUC 110 can provide monitoring of either or both of first encryption device 106 and second encryption device 108, securely through a sandbox connection separate accessible from the secure network. Additionally, method 300 can be executed with secure remote management device 114 is placed into management mode, either manually by actuating a switch, or automatically, upon failure. In embodiments, method 300 can be executed utilizing secure remote management device 114, and or a networked computing system.

In embodiments, devices such as the first router 104, the second router 112, the first cryptographic device 106, the second cryptographic device 108, and NUC 110 can include one or more processing devices coupled to communication devices. The processing device is also coupled to a memory device, and an input/output (“I/O”) interface. In embodiments, the communication device 106 enables communication with other devices and systems via one or more networks.

The processing device, the communication device, the memory device, and the I/O interface can be interconnected via a system bus. The system bus can be and/or include a control bus, a data bus, and address bus, and so forth. The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While a single processing device is mentioned, each device can include multiple processing devices, whether the same type or different types.

The memory device can be and/or include computerized storage medium capable of storing electronic data temporarily, semi-permanently, or permanently. The memory device can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While a single memory device is mentioned, each device can include multiple memory devices, whether the same type or different types.

The communication device enables the devices to communicate with other devices and systems. The communication device can include, for example, a networking chip, one or more antennas, and/or one or more communication ports. The communication device can generate radio frequency (RF) signals and transmit the RF signals via one or more of the antennas. The communication device can generate electronic signals and transmit the RF signals via one or more of the communication ports. The communication device can receive the RF signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received across open space by the communication device.

The communication device can include hardware and/or software for generating and communicating signals over a direct and/or indirect network communication link. As used herein, a direct link can include a link between two devices where information is communicated from one device to the other without passing through an intermediary. For example, the direct link can include an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long-term evolution (“LTE”) standard, and so forth.

The secure remote management device 114 can communicate with one or more network resources via the network 102. The one or more network resources can include external databases, social media platforms, search engines, file servers, web servers, or any type of computerized resource that can communicate with the secure remote management device 114 via the network 102.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions, and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A device for secure remote access, comprising:
a housing;
a first router, disposed in the housing, configured to access at least one first network;
a second router, disposed in the housing, configured to access at least one second network;
a first cryptographic device, disposed in the housing, configured to encrypt at least one data received from one or more devices;
a second cryptographic device, disposed in the housing, configured to encrypt at least one data received from one or more devices, wherein the at least one data is not stored by the second cryptographic device; and
a computing device, disposed in the housing, and communicatively coupled to the first cryptographic device and the second cryptographic device, wherein the computing device is configured to provide remote access to the first cryptographic device and the second cryptographic device.

2. The device of claim 1, wherein the computing device is further configured to provide monitoring to at least one of the first cryptographic device or the second cryptographic device.

3. The device of claim 1, wherein the first cryptographic device is communicatively coupled to the first router and the second router.

4. The device of claim 1, wherein the second cryptographic device is communicatively coupled to the computing device.

5. The device of claim 1, wherein the first cryptographic device further comprises a first Human Machine Interface configured to interface with the first cryptographic device and the second cryptographic device further comprises a second Human Machine Interface configured to interface with the second cryptographic device.

6. A method for secure management or monitoring of at least one computing device, comprising:
monitoring the at least one computing device;
detecting, in response to the monitoring, at least one failure of the at least one computing device;
in response to the detecting, forming at least one secure connection to the at least one computing device; and
performing, utilizing the at least one secure connection, remote management, or monitoring of the at least one computing device.

7. The method of claim 6, wherein the at least one computing device is at least one cryptographic device.

8. The method of claim 7, wherein the at least one cryptographic device is an NSA Type 1 cryptographic device.

9. The method of claim 6, wherein forming the secure connection further comprises:
accessing, through a first port, at least one second cryptographic device communicatively coupled to at least one second computing device configured to access the at least one computing device.

10. The method of claim 9, wherein the performing remote management further comprises:
issuing, by the at least one second computing device, the at least one command to the at least one computing device, wherein the at least one command is forwarded to the at least one second computing device by the at least one second cryptographic device; and
executing, the at least one command.
